(19) United States
(12) Patent Application Publication
(10) Pub. No.: US 2019/0319570 A1
(43) Pub. Date: Oct. 17, 2019

(54) Brushless DC Motor Control System and Method of Configuring the Same

(71) Applicant: Stryker Corporation, Kalamazoo, MI (US)

(72) Inventors: Joshua Mansfield, Lawton, MI (US); Janani Gopalkrishnan, Portage, MI (US); Daniel Brosnan, Kalamazoo, MI (US)

(73) Assignee: Stryker Corporation, Kalamazoo, MI (US)

(21) Appl. No.: 16/293,987

(22) Filed: Mar. 6, 2019

Related U.S. Application Data
(60) Provisional application No. 62/639,259, filed on Mar. 6, 2018.

(51) Int. Cl. H02P 27/04; H02P 27/08

(52) U.S. Cl. CPC H02P 27/047; H02P 27/085

(57) ABSTRACT

A brushless DC motor system includes a brushless DC motor having phases and a controller in communication with the motor for operating the motor in accordance with a commutation table. The controller further has nodes. The system further includes phase wires electrically coupling the motor and the controller at the nodes to form wire-to-node connections for establishing electrical communication paths between the motor and controller along each phase wire. Each phase wire corresponds to one phase of the motor. The controller is programmed to, in response to a user-selected configuration of the wire-to-node connections, generate the commutation table.

### CROSS-REFERENCE TO RELATED APPLICATION

The subject patent application claims priority to and all the benefits of U.S. Provisional Patent Application No. 62/639,259 filed on Mar. 6, 2018, the disclosure of which is hereby incorporated by reference in its entirety.

### TECHNICAL FIELD

The present disclosure relates to configuration of a brushless DC motor control system. Specifically, the present disclosure relates to optimization of the setup process of a brushless DC motor control system through generation of a commutation table for controlling rotation of the brushless DC motor.

### BACKGROUND

Brushless DC motors may operate in accordance with a commutation table that provides sequential phase states for each phase of the motor to generate magnetic fields for rotating a rotor of the motor relative to a stator of the motor. Controllers for brushless DC motors may be programmed to control the motor based on the commutation table. The controller may include nodes for electrically coupling the controller to the phases of the motor using wires, each node being configured for one phase. Further, if the motor has position sensors, the controller may also include nodes for electrically coupling the controller to the sensors using wires.

### BRIEF DESCRIPTION OF THE DRAWINGS

FIG. 1 is a schematic view of a brushless DC motor system in accordance with an embodiment of the present disclosure.

FIG. 2A is a schematic view of the motor and controller of the brushless DC motor system of FIG. 1.

FIG. 2B is a commutation table used to operate the motor illustrated in FIG. 2A.

FIG. 3 is a flowchart illustrating a method of generating a commutation table for the brushless DC motor system of FIG. 1 in accordance with an embodiment of the present disclosure.

FIGS. 4A-4E and FIGS. 5A-5E illustrate the generation of commutation tables in accordance with the method of FIG. 3.

FIG. 6 is a flowchart illustrating a method of generating a commutation table for the brushless DC motor system of FIG. 1 in accordance with another embodiment of the present disclosure.

FIGS. 7A-7C illustrate the generation of commutation tables in accordance with the method of FIG. 6.

FIG. 8 is a flowchart illustrating a method of generating a commutation table for the brushless DC motor system of FIG. 1 in accordance with another embodiment of the present disclosure.

FIG. 9 illustrates the generation of a commutation table in accordance with the method of FIG. 8.

### DETAILED DESCRIPTION

In some brushless DC motor systems, the controller is programmed such that each phase of the motor has to be connected to a specific node on the controller (e.g., via wires). Likewise, if the system includes positional sensors to sense the position of the motor, each sensor has to be connected to a specific node on the controller. In such embodiments, if the phases and sensors are not connected to the corresponding nodes of the controller, the system will not be operational. As such, it may be desirable to have a system that can be operational for any configuration of wire connections, regardless of which phase and sensor is connected to which node of the controller, to ensure functionality and optimize the setup process of the system and decrease labor costs associated with coupling the wires to the controller. With such a system, a technician can connect the phase wires to any of the phase nodes of the controller and can couple the sensor wires to any of the sensor nodes of the controller. Furthermore, using the methods disclosed herein allows the controller to generate the commutation table upon setup based on the motor and how the motor is coupled to the controller, rather than programming the controller with a predetermined commutation table that may only be operational for a certain motor-coupling configuration.

Embodiments of the present disclosure are described herein. The disclosed embodiments are merely examples. Other embodiments may take various and alternative forms. The figures are not necessarily to scale. Some features in the figures could be exaggerated or minimized to show details of particular components. Therefore, specific structural and functional details disclosed herein are not to be interpreted as limiting, but merely as representation. Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Each of the embodiments disclosed herein can be implemented on patient support apparatuses such as, for example and without limitation, cots, stretchers, chairs, tables, wheelchairs, beds, etc. Each of the embodiments disclosed herein can also be implemented on devices other than patient support apparatuses such as, for example and without limitation, power tools, home appliances, etc. Each of the embodiments disclosed herein can be implemented on a number of devices having at least one brushless DC motor.

“Rotation” or “movement” of a motor as described herein may be interpreted as rotation or movement of a rotor of the motor relative to a stator of the motor. Furthermore, as used herein, “commutate” (and derivatives thereof such as “commutation”) may be related to the process of controlling the switches of the system such that the rotor rotates relative to the stator.

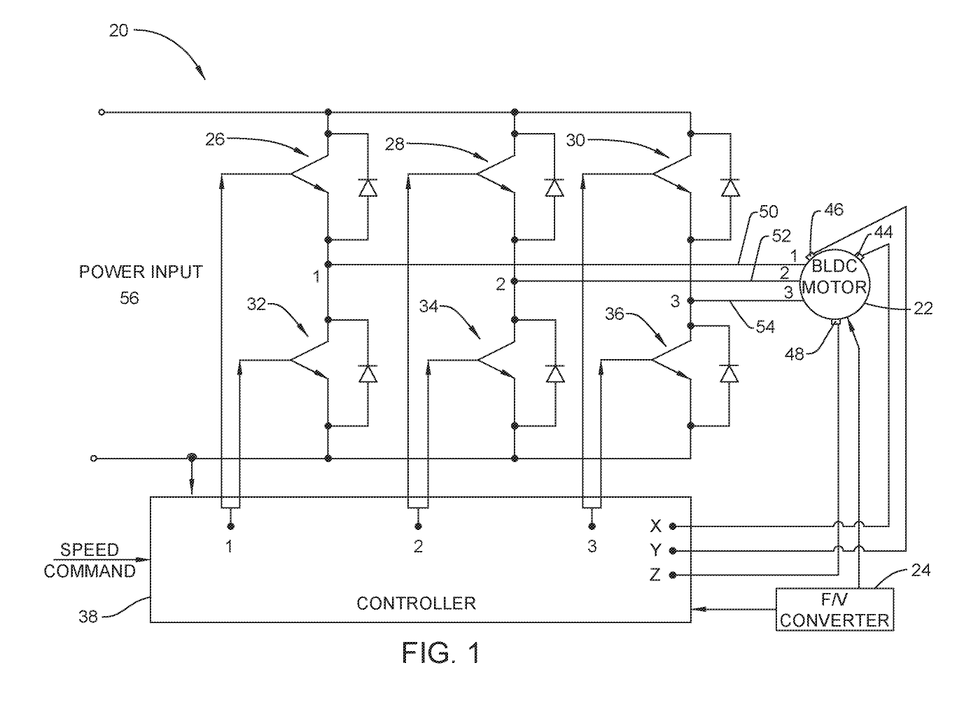

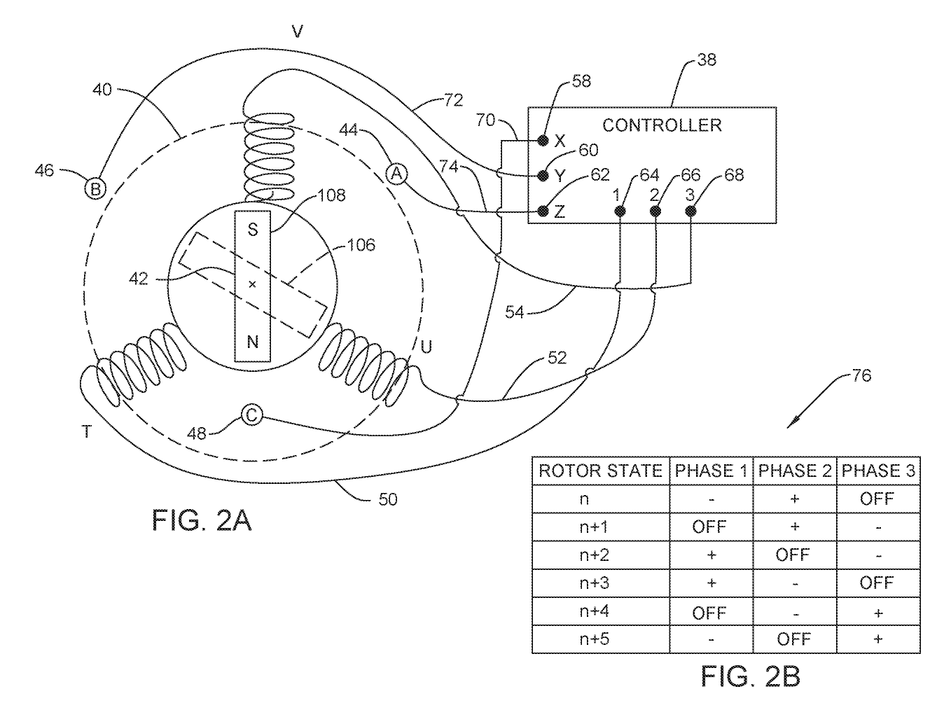

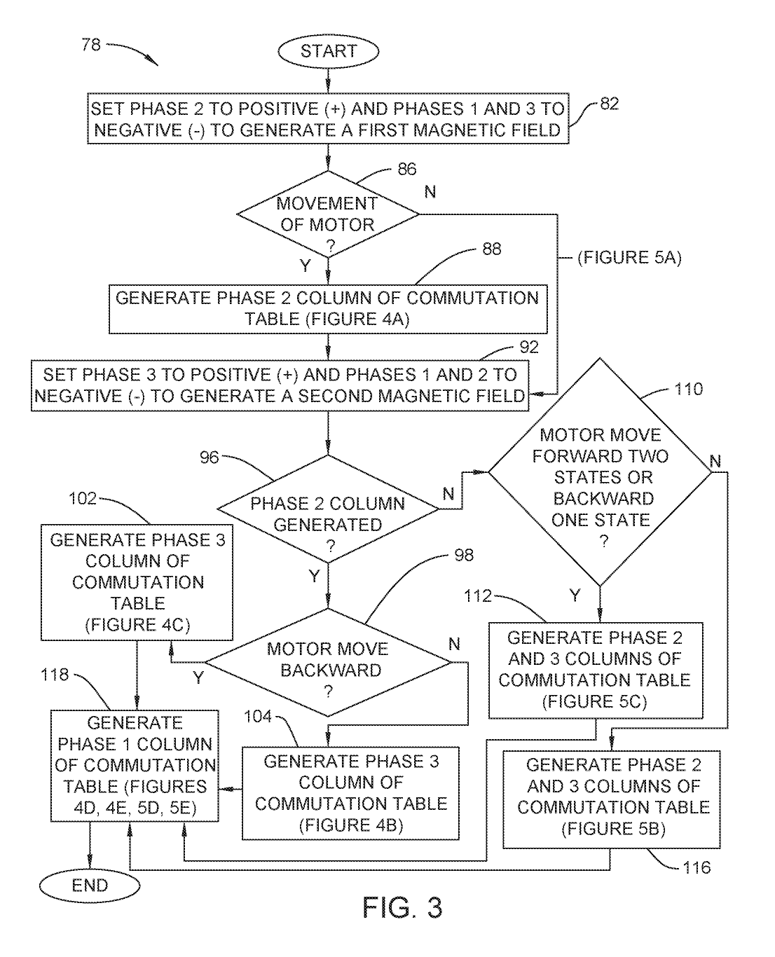

FIG. 1 is a schematic view of a brushless DC motor system 20 in accordance with an embodiment of the present disclosure. In the illustrated embodiment, the system 20 includes a brushless DC motor (BLDC) 22, switches 26, 28, 30, 32, 34, 36, and a controller 38. As will be described in more detail below with reference to FIG. 2A, the motor 22 includes a stator 40 and a rotor 42 that is rotatable relative to the stator 40. In the illustrated embodiment, the system 20 further includes sensors 44, 46, 48, each sensor 44, 46, 48 being configured to output a signal to the controller 38. The signals may be indicative of a position of the rotor 42 relative to the stator 40. In one embodiment, the sensors 44, 46, 48 are commutation position sensors, such as (for example and without limitation) hall sensors, that may be coupled to the stator 40 and/or be fixed relative to the stator 40. The position of the rotor 42 relative to the stator 40 can be determined without the use of sensors. For example and without limitation, in one embodiment, the system 20 senses the position of the rotor 42 relative to the stator 40 by detecting back EMF. There are various other ways to determine the position of the motor 22 in accordance with other embodiments of the present disclosure. In some embodiments, the sensors are external sensors such as rotary encoders.

In the illustrated embodiment, turning the switches 26, 28, 30, 32, 34, 36 on and off controls the flow of current to and from the phases 1, 2, 3 (FIG. 2A) of the motor 22 along phase wires 50, 52, 54, each of which corresponds to one phase 1, 2, 3 of the motor 22. The number of switches 26, 28, 30, 32, 34, 36 may correspond to the number of phases 1, 2, 3 of the motor 22. In one embodiment, two switches control the flow of current through one phase wire. In the illustrated embodiment, the switches 26, 32 control the voltage differential across the phase wire 50, which corresponds to phase 1 of the motor; the switches 28, 34 control the voltage differential across the phase wire 52, which corresponds to phase 2 of the motor; and the switches 30, 36 may control the voltage differential across the phase wire 54, which corresponds to phase 3 of the motor. In the illustrated embodiment, the switches 26, 28, 30 are connected to a positive bus, and the switches 32, 34, 36 are connected to a negative bus. Each pair of switches for each phase may be connected in series with the corresponding phase wire. Gates of the switches 26, 28, 30, 32, 34, 36 may be controlled by the controller 38. In some embodiments, the switches 26, 28, 30, 32, 34, 36 are IGBTs and/or MOSFETs. In one embodiment, the switches 26, 28, 30, 32, 34, 36 are disposed on the same PCB as the controller. In another embodiment, the switches 26, 28, 30, 32, 34, 36 are disposed elsewhere, e.g., on another PCB that is in communication with the controller PCB(s).

The controller 38 may be programmed to control operation of the motor 22 by controlling the gates of the switches 26, 28, 30, 32, 34, 36. In one embodiment, the controller 38 is programmed to send pulse width modulation (PWM) signals to the gates of the switches 26, 28, 30, 32, 34, 36 to effect rotation of the rotor 42 relative to the stator 40. The controller 38 can programmed to receive one or more inputs. In one embodiment, the inputs are a desired speed of the motor 22, an amount of current from a power input 56, an actual speed of the motor 22, a torque of the motor 22, a temperature of the motor 22, and signals from the sensors 44, 46, 48 indicative of the position of the rotor 42 relative to the stator 40.

While illustrated as one controller, the controller 38 may be part of a larger system and/or controlled by other controller(s) throughout the system 20. Therefore, the controller 38 and one or more other controllers not shown in the illustrated embodiment may collectively be referred to as a “controller” that controls various components of the system 20 in response to signals to control functions of the system 20.

In one embodiment, the controller 38 includes a microprocessor (MCU) or central processing unit (CPU) in communication with computer readable storage devices or media. Computer readable storage devices or media may include volatile and nonvolatile storage in read-only memory (ROM), random-access memory (RAM), and keep-alive memory (KAM). Computer-readable storage devices or media may be implemented using memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 38 in controlling the system 20.

The controller 38 may communicate with various sensors and components of the system 20 via an input/output (I/O) interface that may be implemented as a single integrated interface. The interface may provide raw data or signal conditioning, processing, and/or conversion, short-circuit protection, and the like. Alternatively, one or more dedicated hardware or firmware chips may be used to condition and process particular signals before being supplied to the CPU. The controller 38 can control other functions and components of the system 20 not explicitly illustrated in the figures.

Control logic or functions performed by the controller 38 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as the controller 38. The control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the system 20. The computer-readable storage devices or media may include one or more of a number of physical devices which utilize electric, magnetic, and/or optical storage to keep executable instructions and associated calibration information, operating variables, and the like.

FIG. 2A is a schematic view of the motor 22 and controller 38 of the brushless DC motor system 20 of FIG. 1. As shown in FIG. 2A of the illustrated embodiment, the controller 38 has nodes 58, 60, 62, 64, 66, 68 to which wires of the system 20 are electrically coupled such that the controller 38, motor 22, and the sensors 44, 46, 48 are in communication with each other. The nodes 58, 60, 62 may be configured to receive ends of sensor wires 70, 72, 74 of the sensors 44, 46, 48, respectively. The nodes 64, 66, 68 may be configured to receive ends of phase wires 50, 52, 54, respectively. Each node 58, 60, 62, 64, 66, 68 is configured to receive one wire (sensor wire or phase wire). Each of the sensor wires 70, 72, 74 can be coupled to any of the sensors 44, 46, 48. Each of the phase wires 50, 52, 54 can be electrically coupled to any of the windings T, U, V to form a corresponding electrical communication path for the respective phase. There are a variety of ways to couple the wires of the system 20 to the elements of the system 20 at the nodes, such as soldering or inserting a plug coupled to the end of the wire into a corresponding socket at the respective node. In one embodiment, the “node” refers to the point at which two or more electrical components, such as the motor and controller, are joined together to form an electrical communication path between the components. In some embodiments, the node may be the point at which the electrical components are removably coupled to one another. Although the nodes are illustrated as being disposed on the controller 38 and motor 22, the nodes may be disposed elsewhere along the respective electrical communication paths in accordance with other embodiments.

In the illustrated embodiment, the rotor 42 is an internal rotor motor in which permanent magnets are coupled to and rotate with a shaft inside of and relative to the stationary stator 40. The motor 22 may have other rotor-stator configurations, such as (for example and without limitation) an external rotor configuration in which the rotor is positioned externally of the stator. Furthermore, the stator may be slotted or slotless. For simplicity, the rotor 42 in the illustrated embodiment has one N-S pole pair. In other embodiments, the rotor 42 may include more than one N-S pole pair.

Still referring to FIG. 2A, the motor 22 may include windings T, U, V coupled to the stator 40. There are a number of ways to couple the windings to the stator. For example and without limitation, the windings may be coupled to the stator in a star pattern or in a delta pattern. In one embodiment, a number of windings T, U, V of the stator 40 is a multiple of a number of phases 1, 2, 3 of the motor 22. For example and without limitation, in the illustrated embodiment, the number of windings T, U, V is “three,” and the number of phases 1, 2, 3 is “three.”

As shown in FIG. 2A, each phase wire 50, 52, 54 is electrically coupled to at least one winding T, U, V. In one embodiment, each phase wire 50, 52, 54 has an end that is electrically coupled to one of the nodes 64, 66, 68 of the system 30 resulting in a wire-to-node connection. The phase wires electrically couple the motor and controller at the nodes to form the wire-to-node connections for establishing electrical communication paths between the motor and controller along each phase wire. In the illustrated embodiment, the end of the phase wire 50 is electrically coupled to node 64; the end of the phase wire 52 is electrically coupled to node 66; and the end of the phase wire 54 is electrically coupled to node 68.

FIG. 2B is a commutation table 76 used to operate the motor 22 illustrated in FIG. 2A. In the illustrated embodiment, the controller 38 is in communication with the motor 22 for operating the motor 22 in accordance with a commutation table. In one embodiment, the commutation table 76 is programmed into the controller 38 (FIG. 1). As will be described in more detail below, the commutation table 76 of FIG. 2B can be generated by the controller 38 based on the wire-to-node connections. In one embodiment, the commutation table 76 provides logic for controlling the switches 26, 28, 30, 32, 34, 46 to rotate the rotor 42 upon sequential phase excitation. To rotate the rotor 42 relative to the stator 40, the windings T, U, V are energized in sequence in accordance with the commutation table 76 (e.g., by the controller 38). In the illustrated embodiment, the commutation table 76 provides a phase state (e.g., positive, negative, OFF) for each phase 1, 2, 3 based on rotor state in the commutation sequence to generate a changing magnetic field that causes movement of the motor in a rotational direction. Each of the rotor states may correspond to a position of the motor 22 (i.e., position of the rotor 42 relative to the stator 40). The position of the motor 22 may be determined using the sensors 44, 46, 48 (FIG. 2A). In such an embodiment, each of the combination of signals sent from the sensors 44, 46, 48 as outputs to the controller 38 corresponds to one of the rotor states in the commutation table 76. In one embodiment, the correspondence of the rotor states with the outputs of the sensors 26, 28, 30, 32, 34, 36 is predetermined.

In one embodiment, the phase state is positive (+), negative (−), or OFF. The controller 38 can be programmed to operate the gates of the switches 26, 28, 30, 32, 34, 36 to permit voltage control in accordance with the phase state provided in the commutation table 76. In one embodiment, the phase state is different for each phase 1, 2, 3 for a given rotor state. For example and without limitation, and with reference to FIG. 2B, for the given rotor state of “n”, the phase state for Phase 1 is negative; the phase state for Phase 2 is positive; and the phase state for Phase 3 is OFF. In one embodiment, upon moving from an initial rotor state to an adjacent rotor state, which may be the rotor state immediately above or below the initial rotor state in the commutation table 76, one of the phase states for the phases 1, 2, 3 remains the same, and the phase states for the other phases 1, 2, 3 changes. For example and without limitation, and with reference to FIG. 2B, upon moving from the rotor state “n” to the rotor state “n+1”, the phase state for Phase 2 remains positive, and the phase states for Phases 1 and 3 change. Other patterns of commutation switch activation could also lead to clockwise or counterclockwise rotation. Furthermore, although the illustrated embodiment includes three phases 1, 2, 3 and six rotor states in the commutation table 76, there may be more or less phases and rotor states in the commutation table 76 in accordance with other embodiments. In one embodiment, the controller 38 is programmed to, in response to a current position of the rotor 42 relative to the stator 40, determine the next rotor state that would result in rotation of the motor 22. As described hereinabove, the current position of the rotor 42 relative to the stator 40 may be determined by the sensors 44, 46, 48.

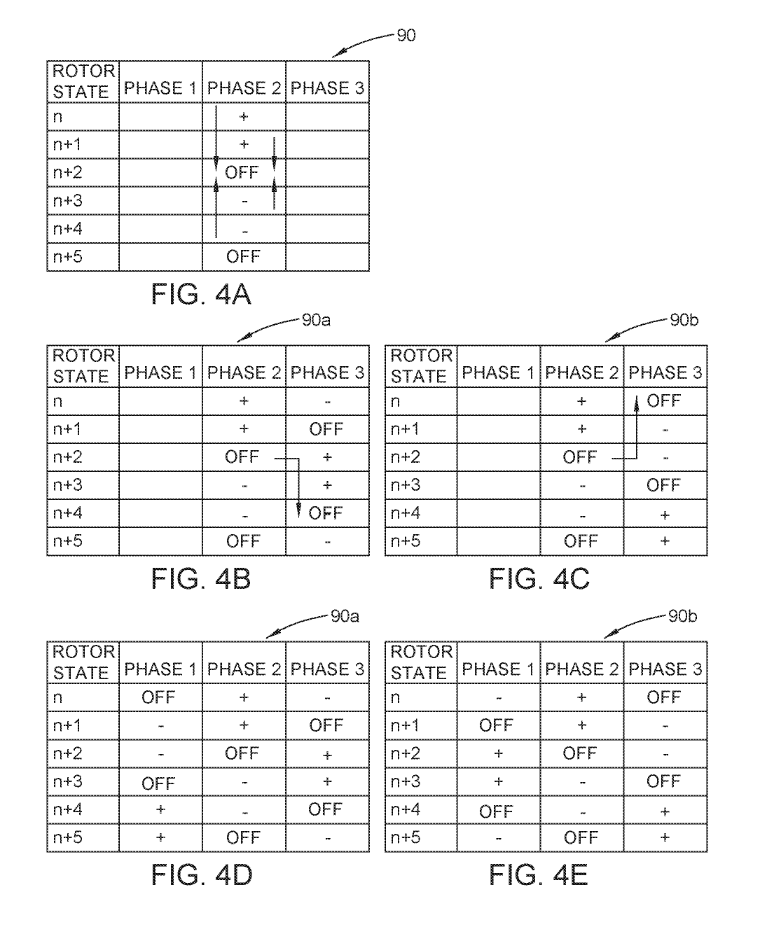

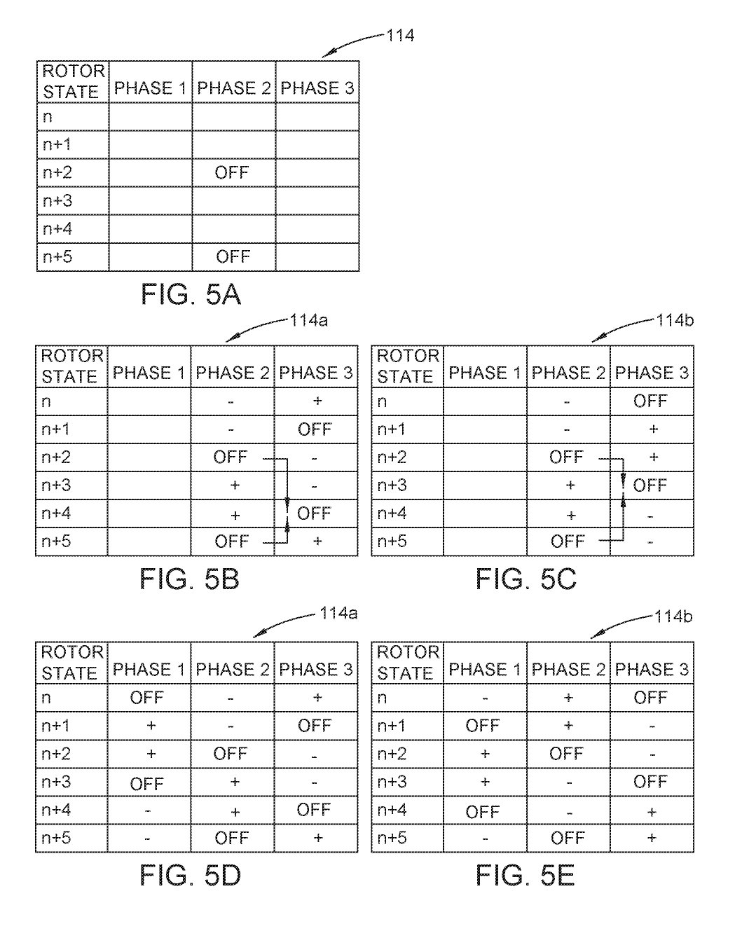

FIG. 3 is a flowchart illustrating a method 78 of generating a commutation table for the system 20 of FIG. 1 in accordance with an embodiment of the present disclosure. The method 78 should not be construed as limited to the configuration as illustrated in FIG. 3, but should include variations where some of the steps may be rearranged and/or removed. The method 78 may be implemented using software code that may be programmed into the controller 38 (FIG. 1). In other embodiments, the method 78 may be programmed into other controllers, or distributed among multiple controllers. FIGS. 4A-4E illustrate the generation of commutation tables 90a, 90b, 114a, 114b in accordance with the method 78 of FIG. 3.

In the illustrated embodiment, the method 78 begins with the step 82 of setting Phase 2 to positive (+) and Phases 1 and 3 to negative (−). This may be referred to as energization of Phase 2. With reference to FIG. 2A, setting the Phases in accordance with step 82 results in generation of a first magnetic field.

In the illustrated embodiment, the method 78 continues with the step 86 of determining whether there is movement of the motor 22 in response to the first magnetic field. Movement of the motor 22 may be determined by comparing the position of the motor 22 before and after step 82. If there was movement of the motor 22 upon energization of Phase 2 in step 82, the method 78 may continue with the step 88 of generating a Phase 2 column of a commutation table 90 in accordance with FIG. 4A. In one embodiment, the phase states for a given phase may follow a pattern based on the rotor state. As the rotor state increases or decreases, each of the phase states of “OFF” may be preceded by a preceding pair of positive or negative phase states and followed by a following pair of positive or negative phase states, wherein the preceding pair and following pair are opposite polarities from one other. For example and without limitation, if the preceding pair is positive, then the following pair may be negative for a given phase state of “OFF.”

If the motor 22 moves in response to the first magnetic field, then the motor 22 moves to a steady-state position in which the motor 22 has rotated due to the generated first magnetic field and reaches an electromagnetic equilibrium at that steady-state position based on the generated magnetic field. Upon movement of the magnetic field when the next phase is energized, the rotor moves to a different steady-state position corresponding with the next energized phase. Based on the first magnetic field and the energization of Phase 2, the steady-state position of the motor 22 may be determined. With brief reference to FIG. 2A, the positions of the windings T, U, V relative to the position of the sensors 44, 46, 48 may be predetermined, and association of the rotor states and positions of the sensors 44, 46, 48 may also be predetermined. In the illustrated embodiment of FIG. 4A, the steady-state position upon energization of Phase 2 corresponds to rotor state of “n+2”. In other embodiments, however, the steady-state position may correspond to a different rotor state.

In the illustrated embodiment, the method 78 continues with the step 92 of setting Phase 3 to positive (+) and Phases 1 and 2 to negative (−). This may be referred to as energization of Phase 3. With reference to FIG. 2A, setting the Phases 1, 2, 3 in accordance with step 92 results in a change in the magnetic field that results in movement of the motor in a clockwise or counterclockwise direction. If the motor 22 did not move in response to the first magnetic field generated in step 82, then the method 78 may bypass the step 88 of generating the Phase 2 column and continue with the step 92.

In the illustrated embodiment, the method 78 continues with the step 96 of determining whether the Phase 2 column was generated. If, at step 86, the motor 22 did not move in response to the first magnetic field generated in step 82, then the Phase 2 column was not generated. If, at step 86, the motor 22 did move in response to the first magnetic field generated in step 82, then the method 78 may continue with the step 98 of determining whether the motor 22 moved backward one position to a steady-state position associated with the prior rotor state (from the rotor state associated with the steady-state position upon energization of Phase 2 in step 82) upon energization of Phase 3 in step 92. If the motor 22 moved in response to the first magnetic field generated in step 82 (upon energization of Phase 2), then upon energization of Phase 3, the motor 22 will move either one position forward or one position backward from the steady-state position to which the motor 22 moved upon energization of Phase 2 in step 82. The Phase 3 column of the commutation table 90 may be generated by determining which direction the motor 22 moved upon energization of Phase 3 in step 92. In the illustrated embodiment, backward movement is movement in an upwards direction in the tables, and forward movement is movement in a downwards direction in the tables. “Forward” movement in the table can correspond to either clockwise or counterclockwise movement of the motor, with backward movement being opposite from the forward direction.

If, at step 96, the controller 38 determines that the motor 22 moved backward one position, then the method 78 may continue with the step 102 of generating a Phase 3 column of the commutation table 90 in accordance with FIG. 4C. If, at step 96, the motor 22 did not move backward one position, then the method 78 may continue with the step 104 of generating a Phase 3 column of the commutation table 90 in accordance with FIG. 4B. In some embodiments, the polarity of the phase states are inverted such that the phase states that are positive (+) become negative (−), and the phase states that are negative (−) become positive (+).

With reference to step 86 in FIG. 3, if the motor 22 did not move in response to the first magnetic field, then the motor 22 may already be in a steady-state position in which the first magnetic field causes no further movement (from the steady-state position). For example and without limitation, and with reference to FIG. 2A, the motor 22 may already be in a steady-state position 106 with its north end or south end aligned with the winding U corresponding to Phase 2. As such, and with reference to FIG. 5A, the Phase 2 column can be partially generated with the phase state for the rotor state associated with the steady-state position 106 being set as “OFF.” The next phase state of “OFF” can also then be set. In one embodiment, the phase states of “OFF” are three rotor states apart. For example and without limitation, if the rotor state for the phase state of “OFF” is “n+2”, then the next phase state of OFF for the same phase corresponds to the rotor state of “n+2+3” or “n+5”. In the illustrated embodiment of FIG. 5A, the steady-state position 106 is determined as corresponding to either rotor state “n+2” or “n+5”, as shown in the commutation table 114. Upon performing step 92 of the method, whether the steady-state position 106 upon energization of Phase 2 corresponds to either “n+2” or “n+5”, the motor 22 moves to the next steady-state position 108 upon energization of Phase 3. In one embodiment, the steady-state position 108 corresponding to energization of Phase 3 corresponds to a rotor state that is between the two possible rotor states corresponding to the steady-state position 106.

With respect to step 96, if the Phase 2 column was not generated (e.g., because the motor 22 did not move (step 86) upon energization of Phase 2), then the method 78 may continue with the step 110 of determining whether the motor 22 moved forward two rotor states or backward one rotor state. If the motor 22 moved forward two states (i.e., increasing in rotor state by two) or backward one state (i.e., decreasing in rotor state by one) upon energization of Phase 3 in step 92, then the method 78 may continue with the step 112 of generating the Phase 2 and Phase 3 columns of a commutation table 114b in accordance with FIG. 5C. If the motor 22 did not move forward two states or backward one state upon energization of Phase 3 in step 92, then the method 78 may continue with the step 116 of generating the Phase 2 and Phase 3 columns of the commutation table 114a in accordance with FIG. 5B. For example and without limitation, and with reference to FIG. 5B, the motor 22 instead moved one state forward or two states backward upon energization of Phase 3.

In some embodiments, determining the direction and amount of movement upon energization of Phase 3 in step 92 allows determination of the phase states in the Phase 2 and Phase 3 columns of the commutation table. In the illustrated embodiment, and with reference to FIG. 5C, if the motor 22 moved forward two states or backward one state upon energization of Phase 3, then the phase states associated with the rotor states toward which the motor 22 moved upon energization of Phase 3 are determined as positive (+). With reference to FIG. 5B, if the motor 22 did not move forward two states or backward one state and instead (for example and without limitation) moved forward one state or backward two states upon energization of Phase 3, then the phase states associated with the rotor states toward which the motor 22 moved upon energization of Phase 3 are determined as negative (−). Once the phase states associated with the rotor states toward which the motor 22 moved (upon energization of Phase 3) is determined, the other two phase states corresponding to the remaining rotor states in the Phase 2 column can be determined. In one embodiment, the other two phase states away from which the motor 22 moved upon energization of Phase 3 are the opposite polarity of the phase states corresponding to the rotor states toward which the motor 22 moved (upon energization of Phase 3). For example and without limitation, if the phase states corresponding to the rotor states toward which the motor 22 moved are negative, then the phase states corresponding to the rotor states away from which the motor 22 moved are positive (within the same phase column, e.g., Phase 2).

In one embodiment, the steady-state position 108 (FIG. 2A) of the motor 22 upon energization of Phase 3 allows determination of the phase state (OFF) for the rotor state associated with the steady-state position 108. In the illustrated embodiment, and with reference to FIG. 5B, the steady-state position 108 upon energization of Phase 3 corresponds to the sequence number of “n+3”. As such, the other phase state of “OFF” are determined in the Phase 3 column as three rotor states away from “n+3”, which may be “n+3+3” (or “n” in a six-step commutation table).

The remaining phase states in the Phase 3 column may also be determined. In one embodiment, the phase state for the rotor state associated with one of phase states of OFF in the Phase 2 column is negative (−), and the phase state for the rotor state associated with the other of the phase states of OFF in the Phase 2 column is positive (+). For example and without limitation, and with reference to FIG. 5B, the phase state in the Phase 3 column for the rotor state “n+2”, which is a rotor state associated with one of the phase states of OFF in the Phase 2 column, is negative (−), and the phase state in the Phase 3 column for the rotor state “n+5”, which is a rotor state associated with the other of the phase states of OFF in the Phase 2 column, is positive (+). The phase states for the adjacent rotor state (“n+1” and “n+4”) may accordingly be completed based on the phase states for each phase column following a pattern of “positive, positive, OFF, negative, negative, OFF.”

Referring back to FIG. 3, the method 78 may continue with the step 118 of generating a Phase 1 column of the commutation table. In one embodiment, the phase state in the Phase 1 column is different than the phase states in the Phase 2 and Phase 3 columns for each rotor state. For example and without limitation, in one embodiment, the phase state in the Phase 1 column for the rotor state “n,” is negative (−) since the phase states for the Phase 2 column and Phase 3 column for the rotor state “n” are positive (+) and OFF, respectively.

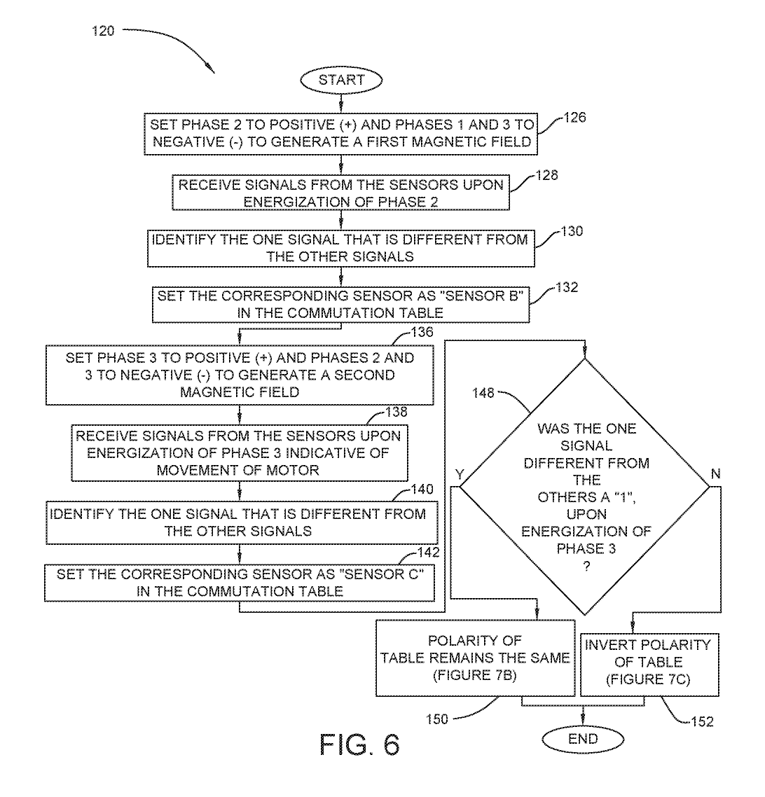

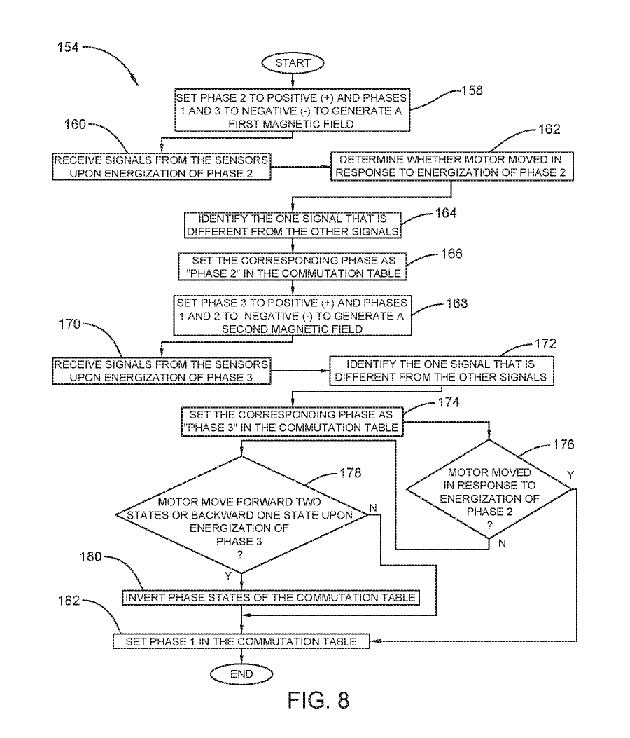

In the method 78 illustrated in FIG. 3, the phases 1, 2, 3 and the rotor states (along with the corresponding rotor positions) are set, and the phase states for each of the phases are determined based on the set rotor states and phases. In the method illustrated in FIG. 6, the phases 1, 2, 3 and the phase states are set, and the rotor states (along with the corresponding rotor positions) and polarity of the table are determined based on the set phases and phase states. In the method illustrated in FIG. 8, the phase states and rotor states (along with the corresponding rotor positions) are set, and the phases are determined based on the phase states and rotor states.

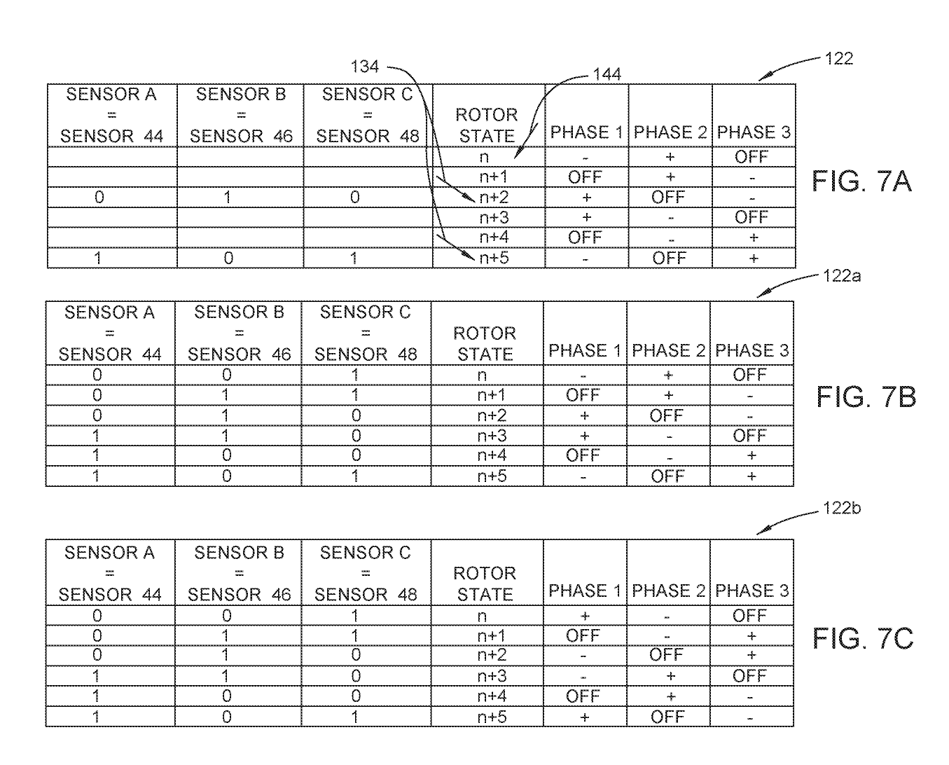

FIG. 6 is a flowchart illustrating a method 120 of generating a commutation table 122a, 122b for the system 20 of FIG. 1 in accordance with an embodiment of the present disclosure. The method 120 should not be construed as limited to the configuration as illustrated in FIG. 6, but should include variations where some of the steps may be rearranged and/or removed. The method 120 may be implemented using software code that may be programmed into the controller 38 (FIG. 1). In other embodiments, the method 120 may be programmed into other controllers, or distributed among multiple controllers. FIGS. 7A-7C illustrate the generation of the commutation tables 122a, 122b in accordance with the method 120 of FIG. 6.

In the illustrated embodiment of FIG. 6, the phase states and phases are set or predetermined. As shown in FIG. 7A, the phase states for a given Phase 1, 2, 3, follow a pattern based on the rotor states. As the rotor state increases or decreases, each of the phase states of “OFF” are preceded by a preceding pair of positive or negative phase states and followed by a following pair of positive or negative phase states, wherein the preceding pair and following pair are opposite polarities from one other. For example and without limitation, if the preceding pair is positive, then the following pair is negative for a given Phase. Furthermore, in one embodiment, the phase states for a given rotor state are different for each phase. For example and without limitation, for a given rotor state, the phase state for Phase 1 is negative (−); the phase state for Phase 2 is positive (+); and the phase state for Phase 3 is “OFF”.

With reference to FIG. 7A, the commutation table 122 is therefore partially generated with the phase states and corresponding signals from the sensors 44, 46, 48 (FIG. 2A). The method illustrated in FIG. 6 may be used to determine the rotor states of the commutation table 122. In one embodiment, each of the signals from the sensors A, B, and C is either a “1” or a “0”. One of the signals may be different from the other signals. For example and without limitation, one of the signals may be a “1” with the other two signals being a “0”, or one of the signals may be a “0” with the other two signals being a “1”. In the illustrated embodiment and with reference to FIG. 2A, Sensor A is sensor 44 disposed opposite the winding T for Phase 1; Sensor B is sensor 46 disposed opposite the winding U for Phase 2; and Sensor C is sensor 48 disposed opposite the winding V for Phase 3. Referring back to FIG. 7A, for each rotor state, the one signal that is different from the other signals corresponds to the sensor 44, 46, 48 that is disposed opposite the winding T, U, V for the Phase 1, 2, 3, with the phase state of “OFF”. For example and without limitation, for the first row in the table 122 of FIG. 7A, the one signal that is different from the other signals is “1”, which corresponds to sensor C. As shown in FIG. 2A, in the illustrated embodiment, sensor C is sensor 48 which is disposed opposite the winding V for Phase 3. Accordingly, the phase state for Phase 3 (for that rotor state), is “OFF”.

In one embodiment, upon moving from an initial rotor state to an adjacent rotor state, which may be the rotor state immediately above or below the initial rotor state in the commutation table 122, one of the phase states for the phases remains the same, and the phase states for the other phases changes. For example and without limitation, and with reference to FIG. 7A, upon moving from the first row of the table 122 (which may be associated with the first rotor state of the table) to the second row immediately below the first row, the phase state for Phase 2 remains positive, and the phase states for Phases 1 and 3 change.

In one embodiment, upon moving from an initial rotor state to an adjacent rotor state, which may be the rotor state immediately above or below the initial rotor state in the commutation table 122, two of the signals from the sensors 44, 46, 48 (A, B, C) remain the same, and the signal from the other sensor changes. For example and without limitation, and with reference to FIG. 7A, upon moving from the first row of the table 122 (which may be associated with the first rotor state of the table 122) to the second row immediately below the first row, the signals for sensors A and C remain the same (“0” and “1”, respectively), and the signal for sensor B changes from “0” to “1”.

In the illustrated embodiment, the method 120 continues with the step 126 of setting Phase 2 to positive (+) and Phases 1 and 3 to negative (−). This may be referred to as energization of Phase 2. Setting the Phases in accordance with step 126 results in the first magnetic field.

In the illustrated embodiment, the method 120 continues with the step 128 of receiving signals from the sensors 44, 46, 48 (A, B, C) upon energization of Phase 2 indicative of movement of the motor 22. As shown in FIG. 1, the controller 38 receives the signals from the sensors 44, 46, 48 in one embodiment.

In the illustrated embodiment, the method 120 continues with the step 130 of identifying the one signal that is different from the others.

In the illustrated embodiment, the method 120 continues with the step 132 of setting the corresponding sensor 44, 46, 48 (that sent the one signal that is different from the other signals upon energization of Phase 2) in the commutation table 122. In the illustrated embodiment, such a sensor is set in the commutation table 122 as “Sensor B”. Upon energization of Phase 2, the motor 22 may rotate such that the signal sent from the sensor B to the controller 38 is “1” and the signals sent from the sensors A and C are “0”. As such, in the illustrated embodiment, the sensor Y is set as sensor B. In other wire-to-node configurations, either sensor X or Y may be set as sensor B. In one embodiment, the sensor disposed opposite the phase 1, 2, 3, (i.e., winding T, U, V) that is energized in step 126 is set as sensor B in step 132.

Upon energization of Phase 2, the motor may move to a steady-state position 106 in which the motor 22 has rotated due to the first generated magnetic field. Based on the first magnetic field and the energization of Phase 2, the steady-state position 106 of the motor 22 can be associated with the rotor state with the phase state of “OFF” in the Phase 2 column. In one embodiment, there are two rotor states at which the phase state is “OFF” for a given phase. In the illustrated embodiment, the steady-state position 106 of the motor 22 upon energization of Phase 2 can be associated with either of the rotor states denoted by the arrows 134 in FIG. 7A, wherein either the north or south end of the rotor 42 is aligned with the winding U of Phase 2 (see FIG. 2A). Upon energization of Phase 2 in step 126, the motor 22 may be aligned such that it does not move. In such a case, a pole of the rotor 42 is already aligned with the winding U of Phase 2. In some instances, the generated magnetic field causes a repulsive force on the pole of the rotor 42, but because of the internal resistance of the motor (e.g., due to gears coupled to the shaft of the rotor), the repulsive force from the magnetic field may not be sufficiently strong to overcome the internal frictional forces within the motor and cause movement thereof.

In the illustrated embodiment, the method 120 continues with the step 136 of setting Phase 3 to positive (+) and Phases 1 and 2 to negative (−). This may be referred to as energization of Phase 3. Setting the Phases in accordance with step 136 results in a second magnetic field different from the first magnetic field such that the rotor may move in a clockwise or counterclockwise direction.

In the illustrated embodiment, the method 120 continues with the step 138 of receiving signals from the sensors 44, 46, 48 (A, B, C) upon energization of Phase 3 indicative of movement of the motor 22. Whether the motor 22 moved in response to the first magnetic field generated upon energization of Phase 2, the motor 22 will move upon energization of Phase 3 in step 136 to a steady-state position 108 (FIG. 2A) in which the north end of the rotor 42 is aligned with the winding V of Phase 3. As shown in FIG. 1, the controller 38 receives the signals from the sensors 44, 46, 48 in one embodiment.

In the illustrated embodiment, the method 120 continues with the step 140 of identifying the one signal that is different from the others. As described hereinabove, the one signal different from the others is a “1” with the others being a “0”, or the one signal different from the others is a “0” with the others being a “1”.

In the illustrated embodiment, the method 120 continues with the step 142 of setting the corresponding sensor 44, 46, 48 (that sent the one signal that is different from the other signals upon energization of Phase 3) in the commutation table 122. In the illustrated embodiment, such a sensor is set in the commutation table 122 as “Sensor C”. Upon energization of Phase 3, the motor 22 will rotate such that the signal sent from the sensor C to the controller 38 is different from the other signals sent from the other sensors A and C. In the illustrated embodiment, the sensor 44 electrically coupled to the node 62 which the controller 38 may identify as “sensor Z” is set as “sensor C” in the commutation table 120. In other wire configurations, either sensor X or Y may be set as sensor C.

Upon energization of Phase 3, the motor 22 will move to a steady-state position 108 in which the motor 22 has rotated due to the second generated magnetic field. Based on the second magnetic field and the energization of Phase 3, the steady-state position 108 of the motor is associated with the rotor state corresponding to the phase state of “OFF” in the Phase 3 column. In one embodiment, there are two rotor states at which the phase state is “OFF” for a given phase. Whether the steady-state position 108 of the motor 22 upon energization of Phase 2 (in step 10) corresponded with either of the rotor states denoted by the arrows 134 in FIG. 7A, the motor 22 will move to the rotor state denoted by the arrow 144 in FIG. 7A upon energization of Phase 3 in step 136.

In the illustrated embodiment, the method 120 continues with the step 148 of determining whether the one signal that is different from the others in step 140 (upon energization of Phase 3) is a “1”. Such a determination can indicate the polarity of the table 122.

If, at step 148, the one signal different from the others (corresponding to Sensor C in step 142) upon energization of Phase 3 is a “1”, then the method 120 may continue with the step 150 of keeping the polarity of the commutation table 122 as is. As such, the phase states within the table 122 remain the same. In one embodiment, the commutation table corresponds to the table 122a illustrated in FIG. 7B.

If, at step 148, the one signal different from the others upon energization of Phase 3 is not a “1” and is instead a “0”, then the method 120 may continue with the step 152 of inverting the polarity of the commutation table. As such, in one embodiment, the phase states of the commutation table 122 illustrated in FIG. 7A are inverted (i.e., the positive (+) phase states become negative (−), and the negative (−) phase states become positive (+)) to correspond with the table 122b illustrated in FIG. 7C.

FIG. 8 is a flowchart illustrating a method 154 of generating a commutation table 156 for the system 20 of FIG. 1 in accordance with an embodiment of the present disclosure. The method 154 should not be construed as limited to the configuration as illustrated in FIG. 8, but should include variations where some of the steps may be rearranged and/or removed. The method 154 may be implemented using software code that may be programmed into the controller 38 (FIG. 1). In other embodiments, the method 154 may be programmed into other controllers, or distributed among multiple controllers.

In the illustrated embodiment, the method 154 begins with the step 158 of setting Phase 2 to positive (+) and Phases 1 and 3 to negative (−). This may be referred to as energization of the Phase 2. Setting the Phases in accordance with step 158 results in generation of a first magnetic field. In the illustrated embodiment, and with reference to FIG. 2A, winding U is energized since winding U is connected to the Phase 2 node at the controller 38.

In the illustrated embodiment, the method 154 continues with the step 160 of receiving signals from the sensors 44, 46, 48 (A, B, C), as shown in FIG. 2A, upon energization of Phase 2. As shown in FIG. 1, the controller 38 receives the signals from the sensors 44, 46, 48 in one embodiment.

In the illustrated embodiment, the method 154 continues with the step 162 of determining whether the motor 22 moved in response to the energization of Phase 2 in step 158. With reference to FIG. 2A, if the motor 22 was already aligned with winding U and sensor A (with its north or south end aligned with sensor A), then the motor 22 may not move in response to energization of Phase 2 in step 158. This determination can be used at a later step of the method 154, as will be described below.

In the illustrated embodiment, the method 154 continues with the step 164 of identifying the one signal that is different from the others. As described hereinabove, the one signal different from the others is a “1” with the others being a “0”, or the one signal different from the others is a “0” with the others being a “1”.

In the illustrated embodiment, the method 154 continues with the step 166 of setting the corresponding Phase in the commutation table 156. In the illustrated embodiment, such Phase is set in the commutation table 156 as “Phase 2”. Referring to FIG. 2A, upon energization of Phase 2, the motor 22 may rotate such that the signal sent from the sensor B (sensor 46) to the controller 38 is different from the other signals sent from the sensors A and C (sensors 44, 48, respectively). As such, in the illustrated embodiment, the winding U, which is disposed opposite the sensor B, is set as being associated with “Phase 2”. In other wire configurations, either winding T or winding V may be set as being associated with “Phase 2”. In one embodiment, the phase disposed opposite the sensor that sent the signal different from that of the other sensors upon energization of Phase 2 is set as Phase 2.

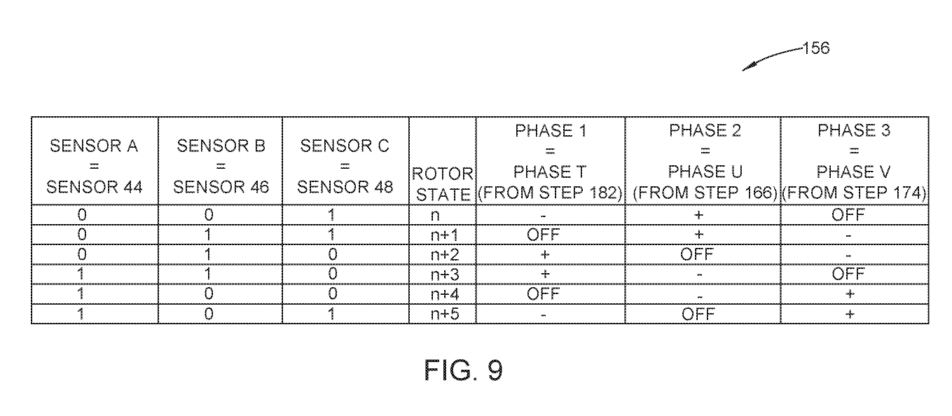

Upon energization of Phase 2, the motor 22 may move to a steady-state position 106 in which the motor 22 has rotated due to the first generated magnetic field. Based on the first magnetic field and the energization of Phase 2, the steady-state position 106 of the motor 22 is determined as the rotor state associated with the phase state of “OFF” in the Phase 2 column. In one embodiment, there are two rotor states at which the phase state is “OFF” for a given phase. In the illustrated embodiment, the steady-state position 106 of the motor 22 upon energization of Phase 2 is associated with either of the “OFF” phase states in the phase 2 column in FIG. 9. Upon energization of Phase 2, the motor 22 may be aligned such that it does not move (i.e., a pole of the rotor 42 is already aligned with the winding U of Phase 2).

In the illustrated embodiment, the method 154 continues with the step 168 of setting Phase 3 to positive (+) and Phases 1 and 2 to negative (−). This may be referred to as energization of Phase 3. Setting the Phases in accordance with step 168 results in a second magnetic field different from the first magnetic field such that the motor moves in a clockwise or counterclockwise direction. In the illustrated embodiment, and with reference to FIG. 2A, winding V is energized since winding V is connected to the Phase 3 node 68 at the controller 38.

In the illustrated embodiment, the method 154 continues with the step 170 of receiving signals from the sensors 44, 46, 48 (A, B, C) upon energization of Phase 3. As shown in FIG. 1, the controller 38 receives the signals from the sensors 44, 46, 48 (A, B, C) in one embodiment.

In the illustrated embodiment, the method 154 continues with the step 172 of identifying the one signal that is different from the other signals. As described hereinabove, the one signal different from the others is a “1” with the others being a “0”, or the one signal different from the others is a “0” with the others being a “1”.

In the illustrated embodiment, the method 154 continues with the step 174 of setting the corresponding phase in the commutation table 156. In the illustrated embodiment, such phase is set in the commutation table 156 as “Phase 3”. Referring to FIG. 2A, upon energization of Phase 3, the motor 22 rotates such that the signal sent from the sensor C (sensor 48 in the illustrated embodiment) to the controller 38 is different from the other signals sent from the sensors A and B (sensors 44, 46, respectively in the illustrated embodiment). As such, in the illustrated embodiment, winding V, which is disposed opposite the sensor C, is set as “Phase 3”. In other wire-to-node configurations, either winding T or winding U may be set as being associated with “Phase 3”. In one embodiment, the phase disposed opposite the sensor that sent the signal different from that of the other sensors upon energization of Phase 3 is set as Phase 3.

In the illustrated embodiment, the method 154 continues with the step 176 of determining whether the motor 22 moved in response to energization of Phase 2 (due to generation of the first magnetic field), which was determined in step 162 in the illustrated embodiment.

If, at step 176, the controller 38 determines that the motor 22 did not move in response to the energization of phase 2, then the method 154 may continue with the step 178 of determining whether the motor 22 moved forward two rotor states or backward one rotor state upon energization of Phase 3. Determining the amount of movement and/or the direction of movement allows determination of the polarity of the table 156 (i.e., determination of non-OFF phase states as negative or positive).

If, at step 178, the controller 38 determines that the motor 22 moved forward two rotor states or backward one rotor state (upon energization of Phase 3), then the method 154 may continue with the step 180 of inverting the phase states of the commutation table 156. In one embodiment, inverting the phase states includes changing the positive (+) phase states to negative (−) and the negative (−) phase states to positive (+). In one embodiment, the motor 22, instead, moves one rotor state backward or two rotor states forward upon energization of Phase 3.

If, at step 178, the controller 38 determines that the motor 22 did not move forward two rotor states or backward one rotor state, then the method 154 may continue with the step 182 of setting Phase 1 of the commutation table 156. Also, after step 180, the method 154 may continue with step 182. Furthermore, if, at step 176, the controller 38 determines that the motor 22 did move in response to the energization of Phase 2, the method 154 may continue with step 182.

By performing any of the methods 78 (FIG. 3), 120 (FIG. 6), 154 (FIG. 8) with the controller 38 (FIG. 1) or the like, a commutation table can be generated for multiple wire-to-node connections of the sensor wires and sensor nodes and/or for multiple wire-to-node configurations of the phase wires and phase nodes. Such flexibility in the wire-to-node configurations may decrease manufacturing costs and ensure functionality of the motor 22 since a technician can couple the sensor wires to any of the sensor nodes and couple the phase wires to any of the phase nodes in creating an operational and effective brushless DC motor system 20. Furthermore, a controller that is configured to perform any of the methods 78, 120, 154 can generate multiple commutation tables for every user-selected configuration of the wire-to-node connections.

In one embodiment, the controller 38 is programmed to, in response to a user-selected configuration of the wire-to-node connections, generate a commutation table.

In one embodiment, the controller 38 is programmed to (i) in response to a first user-selected configuration of the wire-to-node connections, generate a first commutation table, and (ii) in response to a second user-selected configuration of the wire-to-node connections, generate a second commutation table different from the first commutation table, the motor 22 being operable in accordance with the first and second commutation tables.

In one embodiment, a method of configuring a brushless DC motor control system includes, by a controller 38, in response to a user-selected configuration of electrical communication paths between the motor 22 and the controller 38, generating a commutation table that provides logic for operating the motor 22, each electrical communication path corresponding to one phase of the motor 22. The controller 38 may be configured to generate a first portion of the table based on movement of the motor 22 upon energization of a first phase and to generate a second portion of the table based on movement of the motor upon energization of a second phase.

The words used in the specification are words of description rather than limitation, and it is understood that various changes may be made without departing from the spirit and scope of the disclosure. As previously described, the features of various embodiments that may not be explicitly described or illustrated. While various embodiments could have been described as providing advantages or being preferred over other embodiments or prior art implementations with respect to one or more desired characteristics, one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A brushless DC motor system comprising:
a brushless DC motor having phases;
a controller in communication with the motor for operating the motor in accordance with a commutation table, wherein the controller further has nodes; and
phase wires electrically coupling the motor and the controller at the nodes to form wire-to-node connections for establishing electrical communication paths between the motor and controller along each phase wire, wherein each phase wire corresponds to one phase of the motor,
wherein the controller is programmed to, in response to a user-selected configuration of the wire-to-node connections, generate the commutation table.

2. The system of claim 1, further comprising switches for controlling voltage differentials across phase wires electrically coupled to phases of the motor, wherein the commutation table provides a phase state for each of the phases of the motor based on a rotor state to generate a changing magnetic field.

3. The system of claim 2, wherein the controller is programmed to send pulse width modulation signals to gates of the switches in accordance with the commutation table to effect rotation of a rotor of the motor relative to a stator of the motor.

4. The system of claim 2, wherein the changing magnetic field causes a rotor of the motor to rotate relative to a stator of the motor.

5. The system of claim 4, wherein the stator has windings that correspond to the phases of the motor.

6. The system of claim 5, wherein each of the phase wires is electrically coupled to one of the windings to form the corresponding electrical communication path for the respective phase.

7. The system of claim 5, wherein the controller is configured to energize the windings in sequence in accordance with the commutation table.

8. The system of claim 1, wherein each of the nodes is a point at which the motor and controller are joined together to form the corresponding electrical communication paths.

9. The system of claim 1, further comprising sensors configured to output signals to the controller indicative of a position of the motor.

10. The system of claim 9, wherein the signals from the sensors correspond to rotor states in the commutation table.

11. The system of claim 10, wherein the commutation table provides a phase state for each phase based on the rotor state.

12. The system of claim 9, wherein the sensors are hall sensors.

13. The system of claim 1, wherein each of the nodes is configured to receive an end of one of the phase wires.

14. A brushless DC motor system comprising:
a brushless DC motor having phases;
a controller in communication with the motor, wherein the controller has nodes; and
phase wires electrically coupling the motor and the controller at the nodes to form wire-to-node connections for establishing electrical communication paths between the motor and controller along each phase wire, wherein each phase wire corresponds to one phase of the motor,
wherein the controller is programmed to (i) in response to a first user-selected configuration of the wire-to-node connections, generate a first commutation table, and (ii) in response to a second user-selected configuration of the wire-to-node connections, generate a second commutation table different from the first commutation table, and wherein the motor is operable in accordance with the first and second commutation tables.

15. The system of claim 14, wherein each of the first and second commutation tables provides logic for pulse width modulation switching.

16. The system of claim 14, wherein each of the first and second commutation tables provides a phase state for each phase based on a rotor state.

17. The system of claim 16, wherein the phase state is positive, negative, or off.

18. The system of claim 16, wherein the motor includes a stator and a rotor that is rotatable relative to the stator, and wherein the rotor state corresponds to an angular position of the rotor relative to the stator.

19. A method of configuring a brushless DC motor control system, comprising:
by a controller,
in response to a user-selected configuration of electrical communication paths between the motor and the controller, generating a commutation table that provides logic for operating the motor, each electrical communication path corresponding to one phase of the motor.

20. The method of claim 19, wherein the user-selected configuration is defined by wire-to-node connections between phase wires electrically coupling the motor and controller and nodes, wherein each of the phase wires corresponds to one phase of the motor, and each of the nodes is a point at which the motor and controller join together to form the respective electrical circuit.

21. The method of claim 20, wherein the nodes are disposed in the controller.

22. The method of claim 20, wherein the nodes are disposed in the motor.
